(19) United States
(12) Patent Application Publication
(10) Pub. No.: US 2026/0341198 A1
(43) Pub. Date: Oct. 29, 2026

(54) OUTPUT BUFFER CIRCUIT, DISPLAY DEVICE INCLUDING THE OUTPUT BUFFER CIRCUIT, AND ELECTRONIC DEVICE INCLUDING THE DISPLAY DEVICE

(71) Applicant: Samsung Display Co., Ltd., Yongin-si (KR)

(72) Inventors: Mungyu Kim, Yongin-si (KR); Junsoo Ko, Yongin-si (KR); Chankeun Kwon, Yongin-si (KR); Hyungseup Kim, Yongin-si (KR)

(21) Appl. No.: 19/569,511

(22) Filed: Mar. 17, 2026

(30) Foreign Application Priority Data
Apr. 18, 2025 (KR) 10-2025-0050972

(51) Int. Cl. G09G 3/32

(52) U.S. Cl. CPC G09G 3/32; G09G 2310/0275; G09G 2310/0291; G09G 2330/021

(57) ABSTRACT

An output buffer circuit includes an input block which receives an input voltage and generates first and second control voltages based on the input voltage, an output block which outputs an output voltage corresponding to the input voltage based on the first and second control voltages, a first slew rate control block which receives the input voltage and controls a slew rate of the output voltage by generating a first control current, where the first control current controls the first and second control voltages based on the input voltage, and a second slew rate control block which additionally controls the slew rate of the output voltage by generating a second control current, where the second control current additionally controls the first and second control voltages when the first control current is generated.

### CROSS-REFERENCE TO RELATED APPLICATIONS

This application claims priority to Korean Patent Application No. 10-2025-0050972, filed on Apr. 18, 2025, and all the benefits accruing therefrom under 35 U.S.C. §119, the content of which in its entirety is herein incorporated by reference.

### BACKGROUND

### 1. Field

Embodiments of the invention relate to an output buffer circuit, a display device including the output buffer circuit, and an electronic device including the display device.

### 2. Description of the Related Art

A data driver may include a shift register block, a latch block, a digital to analog converter block, an output buffer block, and etc. The output buffer block may include output buffer circuits. One output buffer circuit may transmit a data voltage to two or more data lines. As a driving frequency of a display device increases, a frame rate may increase. As the frame rate increases, a one-line time, which is a time in which the data voltage is transmitted to one pixel row, may be reduced. That is, the display device may be desired to increase a slew rate of the data voltage to transmit the data voltage to two or more data lines by the output buffer circuit during the reduced one-line time.

### SUMMARY

A conventional display device increased the slew rate by increasing a magnitude of a current flowing through the output buffer circuit, but there is a limitation in that power consumption of the display device increases when the magnitude of the current flowing through the output buffer circuit increases.

An embodiment of the invention provides an output buffer circuit which may improve a slew rate of a data voltage without increasing power consumption of a display device.

Another embodiment of the present disclosure provides a display device including the output buffer circuit.

Still another embodiments of the present disclosure provides an electronic device including the display device.

However, embodiments of the present disclosure are not limited to the above objects, and may be variously extended without departing from the spirit and scope of the present disclosure.

According to embodiments, an output buffer circuit includes an input block which receives an input voltage and generates first and second control voltages based on the input voltage, an output block which outputs an output voltage corresponding to the input voltage based on the first and second control voltages, a first slew rate control block which receives the input voltage and controls a slew rate of the output voltage by generating a first control current, where the first control current controls the first and second control voltages based on the input voltage, and a second slew rate control block which additionally controls the slew rate of the output voltage by generating a second control current, where the second control current additionally controls the first and second control voltages when the first control current is generated.

In an embodiment, the output block may include a first transistor including a control electrode connected to a first node to which the first control voltage is applied, a first electrode which receives a first voltage, and a second electrode connected to an output node at which the output voltage is output, a second transistor including a control electrode connected to a second node to which the second control voltage is applied, a first electrode connected to the output node, and a second electrode which receives a second voltage, a first capacitor including a first electrode connected to a third node and a second electrode connected to the output node, and a second capacitor including a first electrode connected to the output node and a second electrode connected to a fourth node.

In an embodiment, the second slew rate control block may include a third transistor including a control electrode connected to a fifth node, a first electrode which receives the first voltage, and a second electrode connected to the fourth node and a fourth transistor including a control electrode connected to a sixth node, a first electrode connected to the third node, and a second electrode which receives the second voltage.

In an embodiment, when a voltage level of the input voltage is higher than a voltage level of a previous output voltage of the output node, the third transistor may be turned off, the fourth transistor may be turned on, the second control current may flow from the third node through the fourth transistor, and a voltage level of the first control voltage may decrease.

In an embodiment, when the voltage level of the first control voltage decreases, the first transistor may be turned on, the second transistor may be turned off, and the output voltage of the output node may reach a target voltage level.

In an embodiment, when a voltage level of the input voltage is lower than a voltage level of a previous output voltage of the output node, the third transistor may be turned on, the fourth transistor may be turned off, the second control current may flow to the fourth node through the third transistor, and a voltage level of the second control voltage may increase.

In an embodiment, when the voltage level of the second control voltage increases, the first transistor may be turned off, the second transistor may be turned on, and the output voltage of the output node may reach a target voltage level.

In an embodiment, the first slew rate control block may include a fifth transistor including a control electrode which receives the input voltage, a first electrode connected to a seventh node, and a second electrode connected to the output node, a sixth transistor including a control electrode which receives the input voltage, a first electrode connected to the output node, and a second electrode connected to an eighth node, a seventh transistor including a control electrode connected to the fifth node, a first electrode which receives the first voltage, and a second electrode connected to the third node, an eighth transistor including a control electrode connected to the fifth node, a first electrode which receives the first voltage, and a second electrode connected to the fifth node, a ninth transistor including a control electrode connected to the seventh node, a first electrode which receives the first voltage, and a second electrode connected to the sixth node, a tenth transistor including a control electrode connected to the seventh node, a first electrode which receives the first voltage, and a second electrode connected to the seventh node, an eleventh transistor including a control electrode connected to the sixth node, a first electrode connected to the fourth node, and a second electrode which receives the second voltage, a twelfth transistor including a control electrode connected to the sixth node, a first electrode connected to the sixth node, and a second electrode which receives the second voltage, a thirteenth transistor including a control electrode connected to the eighth node, a first electrode connected to the fifth node, and a second electrode which receives the second voltage, and a fourteenth transistor including a control electrode connected to the eighth node, a first electrode connected to the eighth node, and a second electrode which receives the second voltage.

In an embodiment, when a voltage level of the input voltage is higher than a voltage level of a previous output voltage of the output node, the eleventh transistor may be turned on, the first control current may flow from the fourth node through the eleventh transistor, and a voltage level of the first control voltage may decrease, and when the voltage level of the first control voltage decreases, the first transistor may be turned on, the second transistor may be turned off, and the output voltage of the output node may reach a target voltage level.

In an embodiment, when a voltage level of the input voltage is lower than a voltage level of a previous output voltage of the output node, the seventh transistor may be turned on, the first control current may flow to the third node through the seventh transistor, and a voltage level of the second control voltage may increase, and when the voltage level of the second control voltage increases, the first transistor may be turned off, the second transistor may be turned on, and the output voltage of the output node may reach a target voltage level.

According to embodiments, a display device includes a display panel including a pixel, a gate driver which provides a gate signal to the pixel, a data driver including an output buffer circuit which provides an output voltage to the pixel, a driving controller which controls the gate driver and the data driver. In such embodiments, the output buffer circuit includes an input block which receives an input voltage and generates first and second control voltages based on the input voltage, an output block which outputs the output voltage corresponding to the input voltage based on the first and second control voltages, a first slew rate control block which receives the input voltage and controls a slew rate of the output voltage by generating a first control current, where the first control current controls the first and second control voltages based on the input voltage, and a second slew rate control block which additionally controls the slew rate of the output voltage by generating a second control current, where the second control current additionally control the first and second control voltages when the first control current is generated.

In an embodiment, the output block may include a first transistor including a control electrode connected to a first node to which the first control voltage is applied, a first electrode which receives a first voltage, and a second electrode connected to an output node at which the output voltage is output, a second transistor including a control electrode connected to a second node to which the second control voltage is applied, a first electrode connected to the output node, and a second electrode which receives a second voltage, a first capacitor including a first electrode connected to a third node and a second electrode connected to the output node, and a second capacitor including a first electrode connected to the output node and a second electrode connected to a fourth node, and the second slew rate control block may include a third transistor including a control electrode connected to a fifth node, a first electrode which receives the first voltage, and a second electrode connected to the fourth node and a fourth transistor including a control electrode connected to a sixth node, a first electrode connected to the third node, and a second electrode which receives the second voltage.

In an embodiment, when a voltage level of the input voltage is higher than a voltage level of a previous output voltage of the output node, the third transistor may be turned off, the fourth transistor may be turned on, the second control current may flow from the third node through the fourth transistor, and a voltage level of the first control voltage may decrease.

In an embodiment, when the voltage level of the first control voltage decreases, the first transistor may be turned on, the second transistor may be turned off, and the output voltage of the output node may reach a target voltage level.

In an embodiment, when a voltage level of the input voltage is lower than a voltage level of a previous output voltage of the output node, the third transistor may be turned on, the fourth transistor may be turned off, the second control current may flow to the fourth node through the third transistor, and a voltage level of the second control voltage may increase.

In an embodiment, when the voltage level of the second control voltage increases, the first transistor may be turned off, the second transistor may be turned on, and the output voltage of the output node may reach a target voltage level.

According to embodiments, an electronic device includes a processor which generates an input control signal and input image data, a display panel including a pixel, a gate driver which provides a gate signal to the pixel, a data driver including an output buffer circuit which provides an output voltage to the pixel, a driving controller which controls the gate driver and the data driver based on the input control signal and the input image data. In such embodiments, the output buffer circuit includes an input block which receives an input voltage and generates first and second control voltages based on the input voltage, an output block which outputs the output voltage corresponding to the input voltage based on the first and second control voltages, a first slew rate control block which receives the input voltage and controls a slew rate of the output voltage by generating a first control current, where the first control current controls the first and second control voltages based on the input voltage, and a second slew rate control block which additionally controls the slew rate of the output voltage by generating a second control current, where the second control current additionally control the first and second control voltages when the first control current is generated.

In an embodiment, the output block may include a first transistor including a control electrode connected to a first node to which the first control voltage is applied, a first electrode which receives a first voltage, and a second electrode connected to an output node at which the output voltage is output, a second transistor including a control electrode connected to a second node to which the second control voltage is applied, a first electrode connected to the output node, and a second electrode which receives a second voltage, a first capacitor including a first electrode connected to a third node and a second electrode connected to the output node, and a second capacitor including a first electrode connected to the output node and a second electrode connected to a fourth node, and the second slew rate control block may include a third transistor including a control electrode connected to a fifth node, a first electrode which receives the first voltage, and a second electrode connected to the fourth node and a fourth transistor including a control electrode connected to a sixth node, a first electrode connected to the third node, and a second electrode which receives the second voltage.

In an embodiment, when a voltage level of the input voltage is higher than a voltage level of a previous output voltage of the output node, the third transistor may be turned off, the fourth transistor may be turned on, the second control current may flow from the third node through the fourth transistor, and a voltage level of the first control voltage may decrease, and when the voltage level of the first control voltage decreases, the first transistor may be turned on, the second transistor may be turned off, and the output voltage of the output node may reach a target voltage level.

In an embodiment, when a voltage level of the input voltage is lower than a voltage level of a previous output voltage of the output node, the third transistor may be turned on, the fourth transistor may be turned off, the second control current may flow to the fourth node through the third transistor, and a voltage level of the second control voltage may increase, and when the voltage level of the second control voltage increases, the first transistor may be turned off, the second transistor may be turned on, and the output voltage of the output node may reach a target voltage level.

Therefore, the output buffer circuit according to embodiments of the invention includes the input block which receives the input voltage and generates the first and second control voltages based on the input voltage, the output block which outputs the output voltage corresponding to the input voltage based on the first and second control voltages, the first slew rate control block which receives the input voltage and controls the slew rate of the output voltage by generating a first control current, where the first control current controls the first and second control voltages based on the input voltage, and the second slew rate control block which additionally controls the slew rate of the output voltage by generating a second control current, where the second control current additionally controls the first and second control voltages when the first control current is generated.

In such embodiments, the output buffer circuit further includes the second slew rate control block compared to a conventional output buffer circuit, so that the output buffer circuit may effectively increase the slew rate of the output voltage output from the output buffer circuit compared to the conventional output buffer circuit without an increase in power consumption of the display device. That is, the output voltage, which is output from the output buffer circuit, may reach a target voltage level faster than the output voltage output from the conventional output buffer circuit without the increase in the power consumption of the display device.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the invention.

FIG. 2 is a circuit diagram illustrating an embodiment of a pixel included in a display panel included in the display device of FIG. 1.

FIG. 3 is a block diagram illustrating an embodiment of a data driver included in the display device of FIG. 1.

FIG. 4 is a block diagram illustrating output buffer circuits included in an output buffer block of the data driver of FIG. 3.

FIG. 5 is a block diagram illustrating an embodiment in which the output buffer circuit of FIG. 4 is connected to data lines through a demux circuit included in a demux block of the data driver of FIG. 3.

FIG. 6 is a block diagram illustrating an embodiment of the output buffer circuit included in the output buffer block of FIG. 4.

FIG. 7 is a circuit diagram illustrating an embodiment of the output buffer circuit included in the output buffer block of FIG. 4.

FIG. 8 is a circuit diagram illustrating an embodiment in which the output buffer circuit of FIG. 6 operates in a rising pattern.

FIG. 9 is a circuit diagram illustrating an embodiment in which the output buffer circuit of FIG. 6 operates in a falling pattern.

FIG. 10 is a graph illustrating a data voltage output from an embodiment of the output buffer circuit of FIG. 6 and a data voltage output from a conventional output buffer circuit.

FIG. 11 is a block diagram illustrating an electronic device according to embodiments of the invention.

FIG. 12 is diagrams illustrating various embodiments of the electronic device of FIG. 11.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in greater detail with reference to the accompanying drawings. The same or like reference numerals are used for the same or like components in the drawings, and any repetitive detailed descriptions of the same or like components will be omitted.

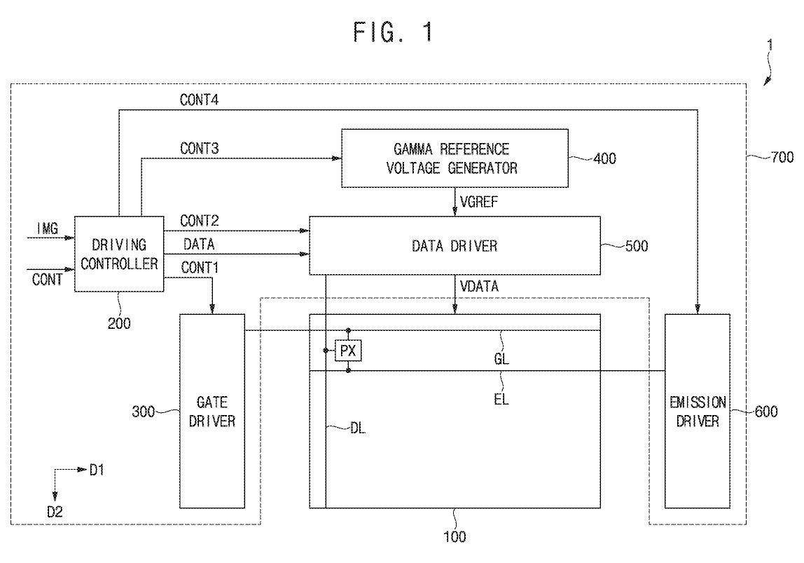

FIG. 1 is a block diagram illustrating a display device 1 according to embodiments of the invention.

Referring to FIG. 1, an embodiment of the display device 1 may include a display panel 100 and display panel driver 700. In an embodiment, the display panel driver 700 may include a driving controller 200, a gate driver 300, a gamma reference voltage generator 400, a data driver 500, and an emission driver 600.

In an embodiment, for example, the driving controller 200 and the data driver 500 may be integrated into a single chip. In an embodiment, for example, the driving controller 200, the gamma reference voltage generator 400, and the data driver 500 may be integrated into a single chip. A driving module including at least the driving controller 200 and the data driver 500 which are integrated into the single chip may be referred to as a timing controller embedded data driver (TED).

The display panel 100 may include a display region on which an image is displayed and a peripheral region adjacent to the display region. In an embodiment, for example, the peripheral region may be referred to as a bezel.

The display panel 100 may include gate lines GL, data lines DL, emission lines EL and pixels PX. In an embodiment, for example, the gate lines GL may extend in a first direction D1 and the emission lines EL may extend in the first direction D1. The data lines DL may extend in a second direction D2 crossing the first direction D1.

The driving controller 200 may receive input image data IMG and an input control signal CONT from an external device. In an embodiment, for example, the input image data IMG may include red image data, green image data, and blue image data. In some embodiments, the input image data IMG may further include white image data. In another embodiment, for example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a gate control signal CONT1, a data control signal CONT2, a gamma control signal CONT3, an emission control signal CONT4, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical gate start signal and a gate clock signal.

The driving controller 200 may generate the data control signal CONT2 for controlling an operation of the data driver 500 based on the input control signal CONT, and may output the data control signal CONT2 to the data driver 500. The data control signal CONT2 may include a horizontal data start signal and a load signal.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 based on the input control signal CONT, and may output the gamma control signal CONT3 to the gamma reference voltage generator 400.

The driving controller 200 may generate the emission control signal CONT4 for controlling an operation of the emission driver 600 based on the input control signal CONT, and may output the emission control signal CONT4 to the emission driver 600. The emission control signal CONT4 may include a vertical emission start signal and an emission clock signal.

The gate driver 300 may generate gate signals transmitted to the pixels PX through the gate lines GL in response to the gate control signal CONT1 received from the driving controller 200. The gate driver 300 may output the gate signals to the gate lines GL.

In an embodiment, the gate driver 300 may be integrated (or integrally formed) on the peripheral region of the display panel 100. In an embodiment, the gate driver 300 may be mounted on the peripheral region of the display panel 100.

The gamma reference voltage generator 400 may generate a gamma reference voltage VGREF in response to the gamma control signal CONT3 received from the driving controller 200. The gamma reference voltage generator 400 may output the gamma reference voltage VGREF to the data driver 500.

In an embodiment, the gamma reference voltage generator 400 may be disposed in the driving controller 200, or in the data driver 500.

The data driver 500 may receive the data control signal CONT2 and the data signal DATA from the driving controller 200. The data driver 500 may receive the gamma reference voltages VGREF from the gamma reference voltage generator 400. The data driver 500 may convert the data signal DATA having a digital type into data voltages having an analog type using the gamma reference voltages VGREF. The data driver 500 may output the data voltages to the data lines DL.

In an embodiment, the data driver 500 may be integrated (or integrally formed) on the peripheral region of the display panel 100. In an embodiment, the data driver 500 may be mounted on the peripheral region of the display panel 100.

The emission driver 600 may generate emission signals transmitted to the pixels PX through the emission lines EL in response to the emission control signal CONT4 received from the driving controller 200. The emission driver 600 may output the emission signals to the emission lines EL.

In an embodiment, the emission driver 600 may be integrated (or integrally formed) on the peripheral region of the display panel 100. In an embodiment, the emission driver 600 may be mounted on the peripheral region of the display panel 100.

In an embodiment, the data driver 500 may include a shift register block, a latch block, a digital-to-analog converter block, an output buffer block, and etc. The output buffer block may include output buffer circuits.

The output buffer circuit may output an output voltage corresponding to the data voltage VDATA.

The output buffer circuit may include an input block which receives an input voltage and generates first and second control voltages based on the input voltage, an output block which outputs the output voltage corresponding to the input voltage based on the first and second control voltages, a first slew rate control block which receives the input voltage and controls a slew rate of the output voltage by generating a first control current which controls the first and second control voltages based on the input voltage, and a second slew rate control block which additionally controls the slew rate of the output voltage by generating a second control current which additionally controls the first and second control voltages when the first control current is generated. Where, the slew rate of the output voltage is a maximum rate of change of the output voltage.

The output buffer circuit further includes the second slew rate control block compared to a conventional output buffer circuit, so that the output buffer circuit may effectively increase the slew rate of the output voltage output from the output buffer circuit without an increase in power consumption of the display device 1 compared to the conventional output buffer circuit. That is, the output voltage output from the output buffer circuit may reach a target voltage level faster than the output voltage output from the conventional output buffer circuit without the increase in power consumption of the display device 1.

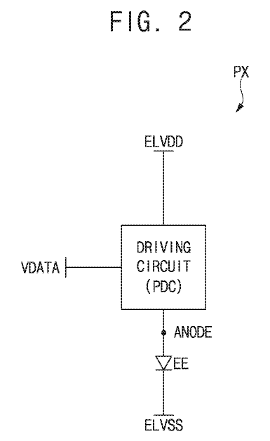

FIG. 2 is a circuit diagram illustrating an embodiment of the pixel PX included in the display panel 100 included in the display device 1 of FIG. 1.

Referring to FIG. 2, an embodiment of the pixel PX may include a driving circuit PDC and a light emitting element EE.

The driving circuit PDC may cause a driving current corresponding to the data voltage VDATA to flow to the light emitting element EE. The driving circuit PDC may be electrically connected to the data line DL to which the data voltage VDATA is applied, a first driving voltage line which provides a first driving voltage ELVDD, and the light emitting element EE. The driving circuit PDC may include a driving transistor. The driving transistor may generate the driving current corresponding to the data voltage VDATA.

The light emitting element EE may include an anode electrode ANODE connected to the driving circuit PDC and a cathode electrode connected to a second driving voltage line which provides a second driving voltage ELVSS. The light emitting element EE may emit light based on the driving current corresponding to the data voltage VDATA. That is, the light emitting element EE may emit light at a luminance corresponding to the data voltage VDATA.

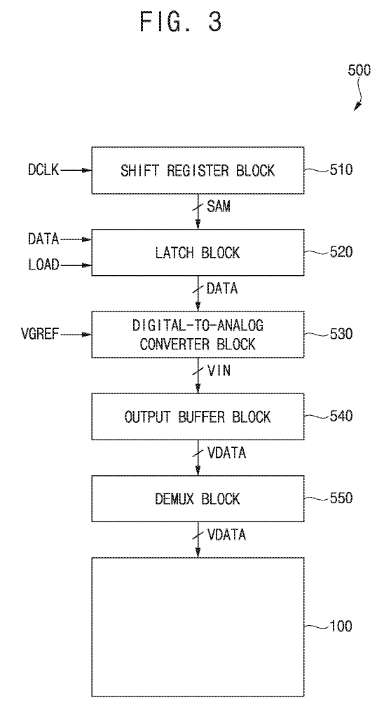

FIG. 3 is a block diagram illustrating an embodiment of the data driver 500 included in the display device 1 of FIG. 1.

Referring to FIG. 3, an embodiment of the data driver 500 may include the shift register block 510, the latch block 520, the digital-to-analog converter block 530, and the output buffer block 540. In some embodiments, the data driver 500 may further include a demux (i.e., demultiplexer) block 550.

The shift register block 510 may receive a data clock signal DCLK. The shift register block 510 may generate sampling signals SAM based on the data clock signal DCLK. The shift register block 510 may output the sampling signals SAM to the latch block 520.

The latch block 520 may receive the data signal DATA, the load signal LOAD, and the sampling signals SAM. The latch block 520 may store the data signal DATA based on the sampling signals SAM and the load signal LOAD and may output the data signal DATA to the digital-to-analog converter block 530.

The digital-to-analog converter block 530 may receive the gamma reference voltage VGREF. The digital-to-analog converter block 530 may receive the data signal DATA from the latch block 520. The digital-to-analog converter block 530 may generate analog voltages VIN based on the data signal DATA and the gamma reference voltage VGREF. In an embodiment, for example, the digital-to-analog converter block 530 may convert the data signal DATA into the analog voltages VIN based on the gamma reference voltage VGREF. The digital-to-analog converter block 530 may output the analog voltages VIN to the output buffer block 540.

The output buffer block 540 may generate the output voltages corresponding to the data voltages VDATA based on the input voltages corresponding to the analog voltages VIN and may output the output voltages to data lines DL. The output buffer block 540 may include the output buffer circuits. The output buffer circuit may generate the output voltage corresponding to the data voltage VDATA based on the input voltage corresponding to the analog voltage VIN and may output the output voltage to the data line DL. In an embodiment, for example, one output buffer circuit may be connected to one data line DL or may be connected to two or more data lines DL through a demux circuit included in the demux block 550.

The demux block 550 may include demux circuits. The demux circuit may be connected to the two or more the data lines DL. In an embodiment, for example, the one output buffer circuit may be connected to the two or more data lines DL through the demux circuit included in the demux block 550. The demux circuit may receive the data voltage VDATA from the output buffer circuit and may output the data voltage VDATA to the one data line DL through a de-multiplexing operation.

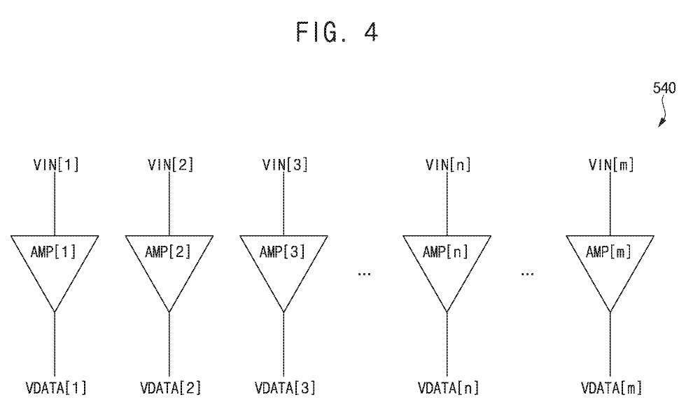

FIG. 4 is a block diagram illustrating the output buffer circuits included in the output buffer block 540 of the data driver 500 of FIG. 3.

Referring to FIG. 4, an embodiment of the output buffer block 540 may include first to m-th output buffer circuits AMP[1] to AMP[m], where m is an integer equal to or greater than 1.

In an embodiment, the digital-to-analog converter block 530 may output first to m-th analog voltages VIN[1] to VIN[m]. Here, m is an integer greater than 1. In an embodiment, for example, the first output buffer circuit AMP[1] may receive the input voltage corresponding to the first analog voltage VIN[1] and may output the output voltage corresponding to a first data voltage VDATA[1] based on the first analog voltage VIN[1]. The second output buffer circuit AMP[2] may receive the input voltage corresponding to the second analog voltage VIN[2] and may output the output voltage corresponding to a second data voltage VDATA[2] based on the second analog voltage VIN[2]. In this way, the m-th output buffer circuit AMP[m] may receive the input voltage corresponding to the m-th analog voltage VIN[m] and may output the output voltage corresponding to an m-th data voltage VDATA[m] based on the m-th analog voltage VIN[m].

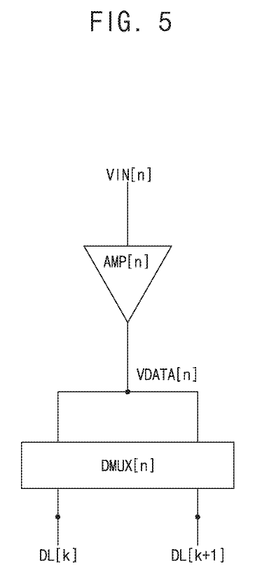

FIG. 5 is a block diagram illustrating an embodiment in which the output buffer circuit AMP of FIG. 4 is connected to data lines DL through the demux circuit DMUX included in the demux block 550 of the data driver 500 of FIG. 3.

Referring to FIG. 5, in an embodiment, the output buffer circuit AMP may be connected to two data lines DL through the demux circuit DMUX. For convenience of description, a case where the output buffer circuit AMP is the n-th output buffer circuit AMP[n], where n is an integer equal to or greater than 1 and equal to or less than m, the demux circuit DMUX is an n-th demux circuit DMUX[n], and the n-th demux circuit DMUX[n] is connected to a k-th data line DL[k], where k is an integer equal to or greater than 1, and a (k+1)-th data line DL[k+1] will be described.

The n-th output buffer circuit AMP[n] may receive the input voltage corresponding to the n-th analog voltage VIN[n] from the digital-to-analog converter block 530. The n-th output buffer circuit AMP[n] may output the output voltage corresponding to the n-th data voltage VDATA[n] to the n-th demux circuit DMUX[n] based on the n-th analog voltage VIN[n]. The n-th demux circuit DMUX[n] may output the n-th data voltage VDATA[n] to the k-th data line DL[k] or the (k+1)-th data line DL[k+1].

In an embodiment, for example, when the n-th data voltage VDATA[n] is the data voltage VDATA to be applied to the k-th data line DL[k], the n-th demux circuit DMUX[n] may output the n-th data voltage VDATA[n] to the k-th data line DL[k]. In addition, when the n-th data voltage VDATA[n] is a data voltage VDATA to be applied to the (k+1)-th data line DL[k+1], the n-th demux circuit DMUX[n] may output the n-th data voltage VDATA[n] to the (k+1)-th data line DL[k+1]. According to embodiments, after the n-th data voltage VDATA[n] to be applied to the k-th data line DL[k] is output to the k-th data line DL[k], the n-th data voltage VDATA[n] to be applied to the (k+1)-th data line DL[k+1] may be output to the (k+1)-th data line DL[k+1], or vice versa.

In this way, the n-th output buffer circuit AMP[n] sequentially outputs the n-th data voltage VDATA[n] to be applied to the k-th data line DL[k] and the n-th data voltage VDATA[n] to be applied to the (k+1)-th data line DL[k+1], so that a driving frequency of the display device 1 increases and the n-th output buffer circuit AMP[n] is desired to rapidly switch between the n-th data voltage VDATA[n] to be applied to the k-th data line DL[k] and the n-th data voltage VDATA[n] to be applied to the (k+1)-th data line DL[k+1]. That is, the slew rate of the data voltage VDATA output from the output buffer circuit AMP is desired to be increased.

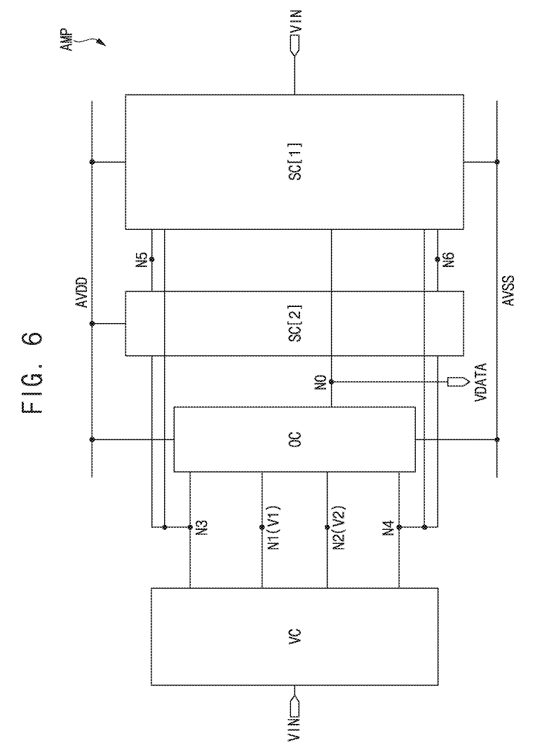

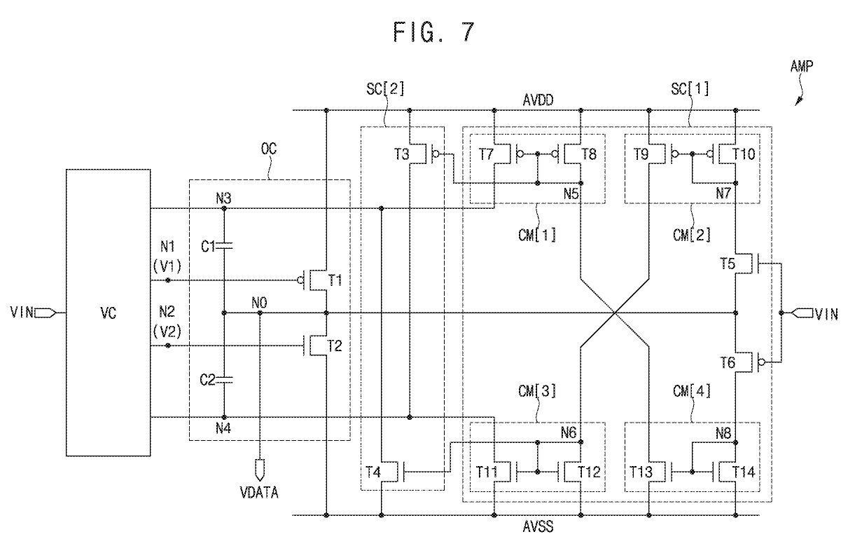

FIG. 6 is a block diagram illustrating an embodiment of the output buffer circuit AMP included in the output buffer block 540 of FIG. 4. FIG. 7 is a circuit diagram illustrating an embodiment of the output buffer circuit AMP included in the output buffer block 540 of FIG. 4.

Referring to FIGS. 6 and 7, an embodiment of the output buffer circuit AMP may include the input block VC, the output block OC, the first slew rate control block SC[1], and the second slew rate control block SC[2].

In an embodiment, the input block VC may receive the analog voltage VIN. That is, the input block VC may receive the analog voltage VIN as an input voltage. The input block VC may be connected to first to fourth nodes N1 to N4. The input block VC may generate the first control voltage V1 and the second control voltage V2 based on the analog voltage VIN. The input block VC may control an operation of the output block OC by applying the first control voltage V1 to the first node N1 and by applying the second control voltage V2 to the second node N2.

In an embodiment, as shown in FIG. 7, the output block OC may include a first transistor T1, a second transistor T2, a first capacitor C1, and a second capacitor C2.

The first transistor T1 may include a control electrode connected to the first node N1 to which the first control voltage V1 is applied, a first electrode which receives a first voltage AVDD, and a second electrode connected to an output node NO which outputs the data voltage VDATA as an output voltage.

The second transistor T2 may include a control electrode connected to the second node N2 to which the second control voltage V2 is applied, a first electrode connected to the output node NO, and a second electrode which receives a second voltage AVSS. Here, the first voltage AVDD and the second voltage AVSS may be high and low supply voltages of the output buffer circuit AMP, respectively.

The first capacitor C1 may include a first electrode connected to the third node N3 and a second electrode connected to the output node NO.

The second capacitor C2 may include a first electrode connected to the output node NO and a second electrode connected to the fourth node N4.

The second slew rate control block SC[2] may include a third transistor T3 and a fourth transistor T4.

The third transistor T3 may include a control electrode connected to a fifth node N5, a first electrode which receives the first voltage AVDD, and a second electrode connected to the fourth node N4.

The fourth transistor T4 may include a control electrode connected to a sixth node N6, a first electrode connected to the third node N3, and a second electrode which receives the second voltage AVSS.

The first slew rate control block SC[1] may include fifth to fourteenth transistors T5 to T14.

The fifth transistor T5 may include a control electrode which receives the analog voltage VIN, a first electrode connected to a seventh node N7, and a second electrode connected to the output node NO.

The sixth transistor T6 may include a control electrode which receives the analog voltage VIN, a first electrode connected to the output node NO, and a second electrode connected to an eighth node N8.

The seventh transistor T7 may include a control electrode connected to the fifth node N5, a first electrode which receives the first voltage AVDD, and a second electrode connected to the third node N3.

The eighth transistor T8 may include a control electrode connected to the fifth node N5, a first electrode which receives the first voltage AVDD, and a second electrode connected to the fifth node N5.

A circuit including the seventh transistor T7 and the eighth transistor T8 may be referred to as a first current mirror circuit CM[1].

The ninth transistor T9 may include a control electrode connected to the seventh node N7, a first electrode which receives the first voltage AVDD, and a second electrode connected to the sixth node N6.

The tenth transistor T10 may include a control electrode connected to the seventh node N7, a first electrode which receives the first voltage AVDD, and a second electrode connected to the seventh node N7.

A circuit including the ninth transistor T9 and the tenth transistor T10 may be referred to as a second current mirror circuit CM[2].

The eleventh transistor T11 may include a control electrode connected to the sixth node N6, a first electrode connected to the fourth node N4, and a second electrode which receives the second voltage AVSS.

The twelfth transistor T12 may include a control electrode connected to the sixth node N6, a first electrode connected to the sixth node N6, and a second electrode which receives the second voltage AVSS.

A circuit including the eleventh transistor T11 and the twelfth transistor T12 may be referred to as a third current mirror circuit CM[3].

The thirteenth transistor T13 may include a control electrode connected to the eighth node N8, a first electrode connected to the fifth node N5, and a second electrode which receives the second voltage AVSS.

The fourteenth transistor T14 may include a control electrode connected to the eighth node N8, a first electrode connected to the eighth node N8, and a second electrode which receives the second voltage AVSS.

A circuit including the thirteenth transistor T13 and the fourteenth transistor T14 may be referred to as a fourth current mirror circuit CM[4].

In an embodiment, each of the first transistor T1, the third transistor T3, and the sixth to tenth transistors T6 to T10 may be implemented as a P-channel metal oxide semiconductor (PMOS) transistor.

In such an embodiment, each of the second transistor T2, the fourth transistor T4, the fifth transistor T5, and the eleventh to fourteenth transistors T11 to T14 may be implemented as an N-channel metal oxide semiconductor (NMOS) transistor.

The output block OC may output the output voltage of the output node NO as the data voltage VDATA based on a voltage of the second node N2 and a voltage of the third node N3. That is, the output block OC may output the output voltage of the output node NO as the data voltage VDATA based on the first control voltage V1 and the second control voltage V2.

The first slew rate control block SC[1] may receive the analog voltage VIN and may generate the first control current which controls the first control voltage V1 and the second control voltage V2 based on the analog voltage VIN. The first control current is a current generated by the first slew rate control block SC[1] to control the slew rate of the output voltage corresponding to the data voltage VDATA. The first slew rate control block SC[1] controls the first control voltage V1 and the second control voltage V2 based on the first control current, so that the first slew rate control block SC[1] may control the slew rate of the output voltage corresponding to the data voltage VDATA.

When the first control current is generated, the second slew rate control block SC[2] may generate the second control current which additionally controls the first control voltage V1 and the second control voltage V2. The second control current is a current generated by the second slew rate control block SC[2] to additionally control the slew rate of the output voltage corresponding to the data voltage VDATA. The second slew rate control block SC[2] additionally controls the first control voltage V1 and the second control voltage V2 based on the second control current, so that the second slew rate control block SC[2] may additionally control the slew rate of the output voltage corresponding to the data voltage VDATA.

For example, a rising pattern is a case in which a voltage level of the output voltage of the output node NO increases based on the input voltage when a voltage level of the input voltage corresponding to the analog voltage VIN is relatively higher than a voltage level of a previous output voltage of the output node NO corresponding to a previous data voltage. When the first slew rate control block SC[1] generates the first control current and the second slew rate control block SC[2] generates the second control current, the slew rate of the output voltage output from the output buffer circuit AMP may be greater than the slew rate of the output voltage output from the conventional output buffer circuit. The slew rate of the output voltage output from the output buffer circuit AMP is greater than the slew rate of the output voltage output from the conventional output buffer circuit, so that in the rising pattern, the voltage level of the output voltage output from the output buffer circuit AMP may increase to reach the target voltage level faster than the voltage level of the output voltage output from the conventional output buffer circuit. That is, in the rising pattern, a voltage level of the data voltage VDATA output from the output buffer circuit AMP may increase to reach the target voltage level faster than a voltage level of the data voltage VDATA output from the conventional output buffer circuit.

For example, a falling pattern is a case in which the voltage level of the output voltage of the output node NO decreases based on the input voltage when the voltage level of the input voltage corresponding to the analog voltage VIN is relatively lower than the voltage level of the previous output voltage of the output node NO corresponding to the previous data voltage. When the first slew rate control block SC[1] generates the first control current and the second slew rate control block SC[2] generates the second control current, the slew rate of the output voltage output from the output buffer circuit AMP may be greater than the slew rate of the output voltage output from the conventional output buffer circuit. The slew rate of the output voltage output from the output buffer circuit AMP is greater than the slew rate of the output voltage output from the conventional output buffer circuit, so that in the falling pattern, the voltage level of the output voltage output from the output buffer circuit AMP may decrease to reach the target voltage level faster than the voltage level of the output voltage output from the conventional output buffer circuit. That is, in the falling pattern, the voltage level of the data voltage VDATA output from the output buffer circuit AMP may decrease to reach the target voltage level faster than the voltage level of the data voltage VDATA output from the conventional output buffer circuit.

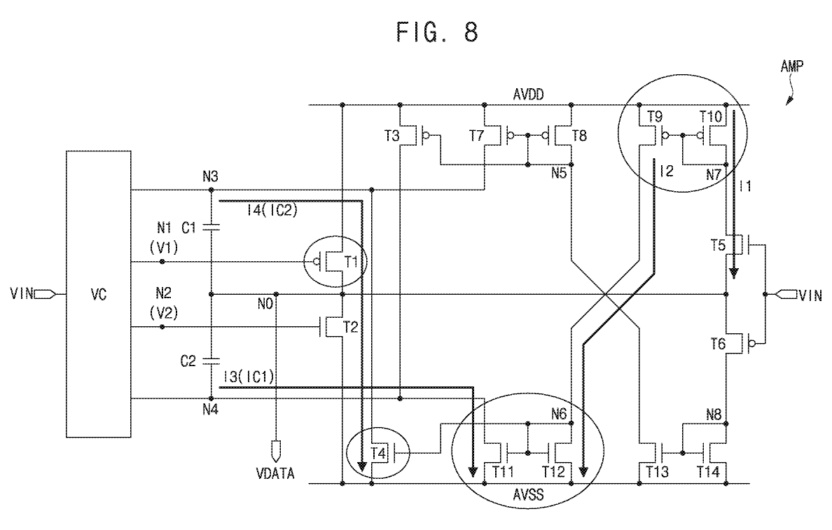

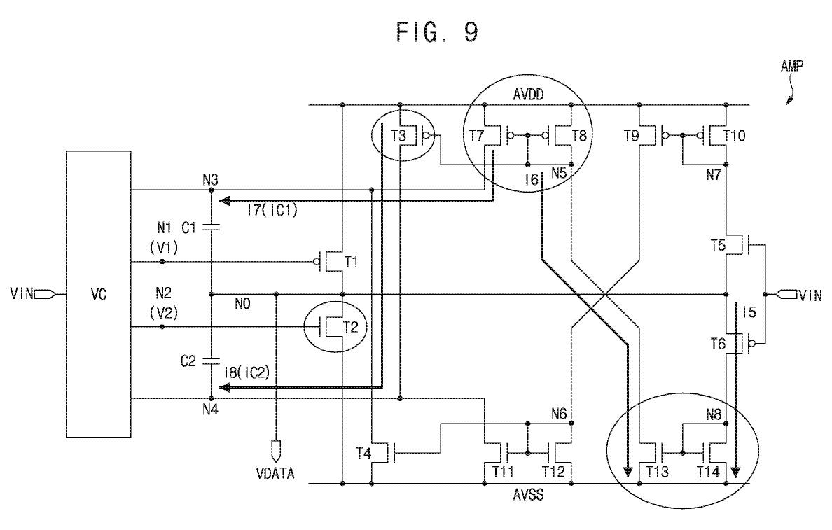

The first control current may be a third current I3 of FIG. 8 or a seventh current I7 of FIG. 9. The second control current may be a fourth current I4 of FIG. 8 or an eighth current I8 of FIG. 9. The operation of the first slew rate control block SC[1] and the operation of the second slew rate control block SC[2] will be described in detail with reference to FIGS. 8 and 9.

In an embodiment, the output buffer circuit AMP further includes the second slew rate control block SC[2] compared to a conventional output buffer circuit, so that the output buffer circuit AMP may effectively increase the slew rate of the output voltage output from the output buffer circuit AMP compared to the conventional output buffer circuit without the increase in the power consumption of the display device 1. That is, the output voltage output from the output buffer circuit AMP may reach the target voltage level faster than the output voltage output from the conventional output buffer circuit without the increase in the power consumption of the display device 1.

FIG. 8 is a circuit diagram illustrating an embodiment in which the output buffer circuit AMP of FIG. 6 operates in the rising pattern.

Referring to FIG. 8, the rising pattern is the case in which the voltage level of the output voltage of the output node NO increases based on the input voltage when the voltage level of the input voltage corresponding to the analog voltage VIN is relatively higher than the voltage level of the previous output voltage of the output node NO corresponding to the previous data voltage. That is, the rising pattern is the case in which the voltage level of the data voltage VDATA increases based on the analog voltage VIN when the voltage level of the analog voltage VIN is higher than the voltage level of the previous data voltage.

In the rising pattern, the voltage level of the input voltage corresponding to the analog voltage VIN is higher than the voltage level of the previous output voltage of the output node NO corresponding to the previous data voltage, so that the fifth transistor T5 may be turned on, and the sixth transistor T6 may be turned off. In the rising pattern, the sixth transistor T6 is turned off, so that the third transistor T3, the seventh transistor T7, the eighth transistor T8, the thirteenth transistor T13, and the fourteenth transistor T14 may be turned off.

In the rising pattern, the fifth transistor T5 is turned on, so that the ninth transistor T9 and the tenth transistor T10 may be turned on.

In the rising pattern, the ninth transistor T9 and the tenth transistor T10 are turned on, so that a first current I1 may flow through the tenth transistor T10, and a second current I2 may flow through the ninth transistor T9. In the rising pattern, the second current I2 flows through the ninth transistor T9, so that a voltage level of a voltage of the sixth node N6 may increase.

In the rising pattern, the voltage level of the voltage of the sixth node N6 increases, so that the eleventh transistor T11 and the twelfth transistor T12 may be turned on.

In the rising pattern, the eleventh transistor T11 and the twelfth transistor T12 are turned on, so that the third current I3 may flow through the eleventh transistor T11, and the second current I2 may flow through the twelfth transistor T12.

In addition, the voltage level of the voltage of the sixth node N6 increases, so that the fourth transistor T4 may be turned on.

That is, when the voltage level of the input voltage corresponding to the analog voltage VIN is higher than the voltage level of the previous output voltage of the output node NO corresponding to the previous data voltage, the third transistor T3 may be turned off and the fourth transistor T4 may be turned on. In this case, the fourth transistor T4 is turned on, so that a fourth current I4 may flow through the fourth transistor T4.

When the voltage level of the input voltage corresponding to the analog voltage VIN is higher than the voltage level of the previous output voltage of the output node NO corresponding to the previous data voltage, the first control current IC1 may be the third current I3, and the second control current IC2 may be the fourth current I4.

When the third current I3 flows from the fourth node N4 through the eleventh transistor T11, the voltage level of the first control voltage V1 may decrease and the voltage level of the second control voltage V2 may decrease. In addition, when the fourth current I4 flows from the third node N3 through the fourth transistor T4, the voltage level of the first control voltage V1 may additionally decrease and the voltage level of the second control voltage V2 may additionally decrease.

When the third current I3 flows from the fourth node N4 through the eleventh transistor T11, the voltage level of the voltage of the fourth node N4 may decrease. In this case, the voltage level of the voltage of the fourth node N4 decreases, so that the voltage level of the second control voltage V2 applied to the second node N2 may decrease. In this case, the voltage level of the second control voltage V2 decreases, so that the voltage level of the first control voltage V1 applied to the first node N1 may decrease.

In addition, when the fourth current I4 flows from the third node N3 through the fourth transistor T4, the voltage level of a voltage of the third node N3 may decrease. In this case, the voltage level of the voltage of the third node N3 decreases, so that the voltage level of the first control voltage V1 applied to the first node N1 may additionally decrease. In this case, the voltage level of the first control voltage V1 additionally decreases, so that the voltage level of the second control voltage V2 applied to the second node N2 may additionally decrease.

When the voltage level of the first control voltage V1 decreases and the voltage level of the second control voltage V2 decreases, the first transistor T1 may be turned on and the second transistor T2 may be turned off.

When the first transistor T1 is turned on and the second transistor T2 is turned off, the voltage level of the output voltage of the output node NO may increase. That is, the voltage level of the data voltage VDATA of the output node NO may increase.

In the rising pattern, the third current I3 flows from the fourth node N4 through the eleventh transistor T11 and the fourth current I4 additionally flows from the third node N3 through the fourth transistor T4, so that the voltage level of the first control voltage V1 applied to the first node N1 of the output buffer circuit AMP may decrease faster than the voltage level of the first control voltage of the conventional output buffer circuit. Accordingly, the first transistor T1 of the output buffer circuit AMP may be turned on faster than the first transistor of the conventional output buffer circuit. In this case, the first transistor T1 of the output buffer circuit AMP is turned on faster than the first transistor of the conventional output buffer circuit, so that the voltage level of the output voltage of an output node NO of the output buffer circuit AMP may increase faster than the voltage level of the output voltage of the output node of the conventional output buffer circuit. Accordingly, the slew rate of the output voltage of the output buffer circuit AMP may be higher than the slew rate of the output voltage of the conventional output buffer circuit. That is, the slew rate of the data voltage VDATA of the output buffer circuit AMP may be higher than the slew rate of the data voltage of the conventional output buffer circuit.

FIG. 9 is a circuit diagram illustrating an embodiment in which the output buffer circuit AMP of FIG. 6 operates in the falling pattern.

Referring to FIG. 9, the falling pattern is the case in which the voltage level of the output voltage of the output node NO decreases based on an input voltage when the voltage level of the input voltage corresponding to the analog voltage VIN is relatively lower than the voltage level of the previous output voltage of the output node NO corresponding to the previous data voltage. That is, the falling pattern is the case in which the voltage level of the data voltage VDATA decreases based on the analog voltage VIN when the voltage level of the analog voltage VIN is lower than the voltage level of the previous data voltage.

In the falling pattern, the voltage level of the input voltage corresponding to the analog voltage VIN is lower than the voltage level of the previous output voltage of the output node NO corresponding to the previous data voltage, so that the fifth transistor T5 may be turned off and the sixth transistor T6 may be turned on. In the falling pattern, the fifth transistor T5 is turned off, so that the fourth transistor T4 and the ninth to twelfth transistors T9 to T12 may be turned off.

In the falling pattern, the sixth transistor T6 is turned on, so that the thirteenth transistor T13 and the fourteenth transistor T14 may be turned on.

In the falling pattern, the thirteenth transistor T13 and the fourteenth transistor T14 are turned on, so that a fifth current I5 may flow through the fourteenth transistor T14 and a sixth current I6 may flow through the thirteenth transistor T13. The sixth current I6 flows through the thirteenth transistor T13, so that a voltage level of a voltage of the fifth node N5 may decrease.

In the falling pattern, the voltage level of the voltage of the fifth node N5 decreases, so that the seventh transistor T7 and the eighth transistor T8 may be turned on.

In the falling pattern, the seventh transistor T7 and the eighth transistor T8 are turned on, so that the sixth current I6 may flow through the eighth transistor T8 and the seventh current I7 may flow through the seventh transistor T7.

In the falling pattern, the voltage level of the voltage of the fifth node N5 decreases, so that the third transistor T3 may be turned on.

That is, when the voltage level of the input voltage corresponding to the analog voltage VIN is lower than the voltage level of the previous output voltage of the output node NO corresponding to the previous data voltage, the third transistor T3 may be turned on and the fourth transistor T4 may be turned off. In this case, the third transistor T3 is turned on, so that an eighth current I8 may flow through the third transistor T3.

When the voltage level of the input voltage corresponding to the analog voltage VIN is lower than the voltage level of the previous output voltage of the output node NO corresponding to the previous data voltage, the first control current IC1 may be the seventh current I7 and the second control current IC2 may be the eighth current I8.

When the seventh current I7 flows to the third node N3 through the seventh transistor T7, the voltage level of the first control voltage V1 increases and the voltage level of the second control voltage V2 may increase. In addition, when the eighth current I8 flows to the fourth node N4 through the third transistor T3, the voltage level of the first control voltage V1 additionally increases, and the voltage level of the second control voltage V2 may additionally increase.

When the seventh current I7 flows to the third node N3 through the seventh transistor T7, the voltage level of the voltage of the third node N3 may increase. In this case, the voltage level of the voltage of the third node N3 increases, so that the voltage level of the first control voltage V1 applied to the first node N1 may increase. In this case, the voltage level of the first control voltage V1 increases, so that the voltage level of the second control voltage V2 applied to the second node N2 may increase.

In addition, when the eighth current I8 flows to the fourth node N4 through the third transistor T3, the voltage level of the voltage of the fourth node N4 may increase. In this case, the voltage level of the voltage of the fourth node N4 increases, so that the voltage level of the second control voltage V2 applied to the second node N2 may additionally increase. In this case, the voltage level of the second control voltage V2 additionally increases, so that the voltage level of the voltage of the first node N1 may additionally increase.

When the voltage level of the first control voltage V1 increases and the voltage level of the second control voltage V2 increases, the first transistor T1 may be turned off and the second transistor T2 may be turned on.

When the first transistor T1 is turned off and the second transistor T2 is turned on, the voltage level of the output voltage of the output node NO may decrease. That is, the voltage level of the data voltage VDATA of the output node NO may decrease.

In the falling pattern, the seventh current I7 flows to the third node N3 through the seventh transistor T7 and the eighth current I8 additionally flows to the fourth node N4 through the third transistor T3, so that the voltage level of the second control voltage V2 applied to the second node N2 of the output buffer circuit AMP may increase faster than the voltage level of the second control voltage of the conventional output buffer circuit. Accordingly, the second transistor T2 of the output buffer circuit AMP may be turned on faster than the second transistor of the conventional output buffer circuit. In this case, the second transistor T2 of the output buffer circuit AMP is turned on faster than the second transistor of the conventional output buffer circuit, so that the voltage level of the output voltage of the output node NO of the output buffer circuit AMP may decrease faster than the voltage level of the output voltage of the output node of the conventional output buffer circuit. Accordingly, the slew rate of the output voltage of the output buffer circuit AMP may be higher than the slew rate of the output voltage of the conventional output buffer circuit. That is, the slew rate of the data voltage VDATA of the output buffer circuit AMP may be higher than the slew rate of the data voltage of the conventional output buffer circuit.

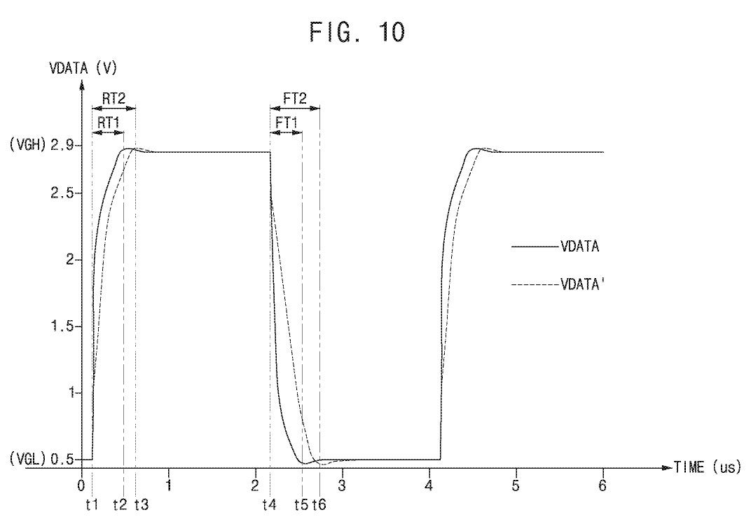

FIG. 10 is a graph illustrating a data voltage VDATA output from an embodiment of the output buffer circuit AMP of FIG. 6 and a data voltage VDATA’ output from a conventional output buffer circuit.

Referring to FIG. 10, in an embodiment, the output buffer circuit AMP further includes the third transistor T3 and the fourth transistor T4, so that the slew rate of the data voltage VDATA may effectively increase without the increase in the power consumption of the display device 1.

In an embodiment, in the rising pattern, the voltage level of the data voltage VDATA may increase. In an embodiment, for example, the data voltage VDATA of the output buffer circuit AMP may have a first voltage level VGL at a first time point t1. In the rising pattern, the output buffer circuit AMP may change the voltage level of the data voltage VDATA from the first voltage level VGL to a second voltage level VGH higher than the first voltage level VGL from the first time point t1. That is, the voltage level of the data voltage VDATA of an embodiment of the output buffer circuit AMP may increase from the first time point t1. In such an embodiment, the data voltage VDATA of the output buffer circuit AMP may have the second voltage level VGH at a second time point t2. A difference between the second time point t2 and the first time point t1 is a first rising time RT1.

The data voltage VDATA’ of the conventional output buffer circuit may have the first voltage level VGL at the first time point t1. The conventional output buffer circuit may change the voltage level of the data voltage VDATA’ from the first voltage level VGL to the second voltage level VGH from the first time point t1. That is, the voltage level of the data voltage VDATA’ of the conventional output buffer circuit may increase from the first time point t1. The data voltage VDATA’ of the conventional output buffer circuit may have the second voltage level VGH at a third time point t3. A difference between the third time point t3 and the first time point t1 is a second rising time RT2.

In an embodiment, the output buffer circuit AMP further includes the second slew rate control block SC[2] compared to the conventional output buffer circuit, so that the second time point t2 may be earlier than the third time point t3. In such an embodiment, the second time point t2 is earlier than the third time point t3, so that the first rising time RT1 may be shorter than the second rising time RT2. The first rising time RT1 is shorter than the second rising time RT2, so that the voltage level of the data voltage VDATA of an embodiment of the output buffer circuit AMP may increase faster than the voltage level of the data voltage VDATA’ of the conventional output buffer circuit. That is, the slew rate of the data voltage VDATA of an embodiment of the output buffer circuit AMP may be higher than the slew rate of the data voltage VDATA’ of the conventional output buffer circuit.

In an embodiment, in the falling pattern, the voltage level of the data voltage VDATA may decrease. In an embodiment, for example, the data voltage VDATA of the output buffer circuit AMP may have the second voltage level VGH at a fourth time point t4. In such an embodiment, the output buffer circuit AMP may change the voltage level of the data voltage VDATA from the second voltage level VGH to the first voltage level VGL lower than the second voltage level VGH from the fourth time point t4. That is, the voltage level of the data voltage VDATA of an embodiment of the output buffer circuit AMP may decrease from the fourth time point t4. The data voltage VDATA of an embodiment of the output buffer circuit AMP may have the first voltage level VGL at a fifth time point t5. A difference between the fifth time point t5 and the fourth time point t4 is a first falling time FT1.

The data voltage VDATA’ of the conventional output buffer circuit may have the second voltage level VGH at the fourth time point t4. The conventional output buffer circuit may change the voltage level of the data voltage VDATA’ from the second voltage level VGH to the first voltage level VGL from the fourth time point t4. That is, the voltage level of the data voltage VDATA’ of the conventional output buffer circuit may decrease from the fourth time point t4. The data voltage VDATA’ of the conventional output buffer circuit may have the first voltage level VGL at a sixth time point t6. A difference between the sixth time point t6 and the fourth time point t4 is a second falling time FT2.

In an embodiment, the output buffer circuit AMP further includes the second slew rate control block SC[2] compared to the conventional output buffer circuit, so that the fifth time point t5 may be earlier than the sixth time point t6. In such an embodiment, the fifth time point t5 is earlier than the sixth time point t6, so that the first falling time FT1 may be shorter than the second falling time FT2. The first falling time FT1 is shorter than the second falling time FT2, so that the voltage level of the data voltage VDATA of an embodiment of the output buffer circuit AMP may decrease faster than the voltage level of the data voltage VDATA’ of the conventional output buffer circuit. That is, the slew rate of the data voltage VDATA of an embodiment of the output buffer circuit AMP may be higher than the slew rate of the data voltage VDATA’ of the conventional output buffer circuit.

In an embodiment, the output buffer circuit AMP further includes the second slew rate control block SC[2] compared to the conventional output buffer circuit, so that the output buffer circuit AMP may effectively increase the slew rate of the data voltage VDATA output from an embodiment of the output buffer circuit AMP compared to the conventional output buffer circuit without the increase in the power consumption of the display device 1. That is, the data voltage VDATA output from an embodiment of the output buffer circuit AMP may reach the target voltage level faster than the data voltage output from the conventional output buffer circuit without the increase in the power consumption of the display device 1.

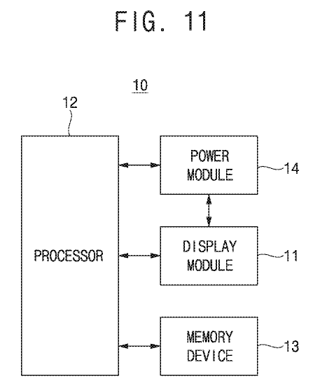

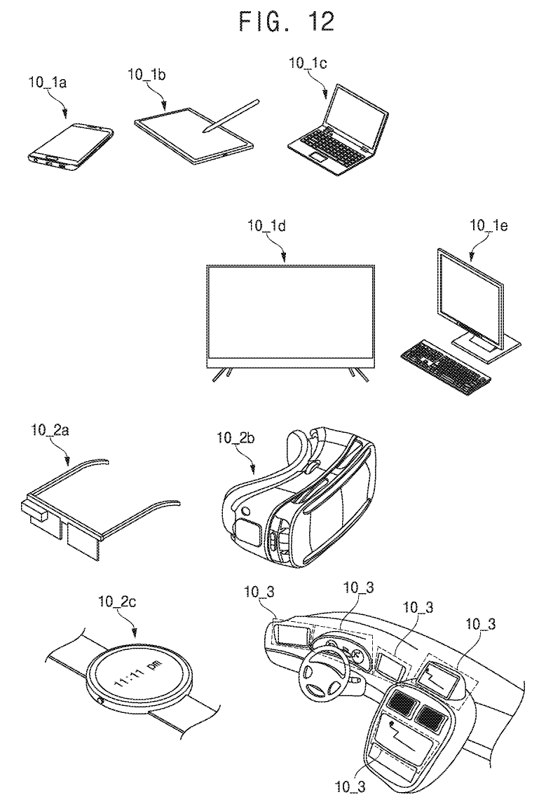

FIG. 11 is a block diagram illustrating an electronic device 10 according to embodiments of the invention. FIG. 12 is diagrams illustrating various embodiments of the electronic device 10 of FIG. 11.

Referring to FIG. 11, an embodiment of the electronic device 10 may include a display module 11, a processor 12, a memory device 13, and a power module 14.

The display device 1 according to embodiments may be applied to various electronic devices.

In an embodiment, the electronic device 10 may include the display device 1 of FIG. 1. That is, an operation of the display device 1 included in the electronic device 10 may be the same as an operation of the display device 1 described with reference FIGS. 1-10.

The display device 1 included in the electronic device 10 may include the data driver 500. The data driver 500 may include the shift register block 510, the latch block 520, the digital-to-analog converter block 530, the output buffer block 540, and etc. The output buffer block 540 may include the output buffer circuits AMP.

In an embodiment, the output buffer circuit AMP may include the input block VC, the first slew rate control block SC[1], the second slew rate control block SC[2], and the output block OC. That is, the output buffer circuit AMP may further include the second slew rate control block SC[2] compared to a conventional output buffer circuit.

In an embodiment, the output buffer circuit AMP further includes the second slew rate control block SC[2] compared to the conventional output buffer circuit, so that the output buffer circuit AMP may effectively increase the slew rate of the output voltage output from the output buffer circuit AMP compared to the conventional output buffer circuit without the increase in the power consumption of the display device 1. That is, the output voltage output from the output buffer circuit AMP may reach the target voltage level faster than the output voltage output from the conventional output buffer circuit without the increase in the power consumption of the display device 1.

The electronic device 10 may further include modules or devices having other additional functions in addition to the display device 1.

The processor 12 may include at least one selected from a central processing unit (CPU), an application processor (AP), a graphic processing unit (GPU), a communication processor (CP), an image signal processor (ISP), and controller.

In an embodiment, the processor 12 may provide the input control signal CONT of FIG. 1 and the input image data IMG of FIG. 1 to the driving controller 200 included in the display device 1 of FIG. 1.

In an embodiment, the processor 12 may be provided as two or more forms in terms of functionality or structure. In an embodiment, for example, the processor 12 may include a main processor in the form of a first driving chip including the central processing unit and an auxiliary processor in the form of a second driving chip including the controller that receives an image signal from the main processor and processes the image signal to conform interface specifications of the display module 11. The auxiliary processor may include the driving controller 200 included in the display device 1 of FIG. 1. Accordingly, the main processor may provide the input control signal CONT of FIG. 1 and the input image data IMG of FIG. 1 to the auxiliary processor. The auxiliary processor may process the image signal based on the input control signal CONT and the input image data IMG.

The memory device 13 may include at least one of a non-volatile memory device and a volatile memory device. Data information for an operation of the display module 11 or the processor 12 may be stored in the memory device 13. When the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel.

The power module 13 may include a power supply module, such as a power adapter or a battery device, and a power conversion module that converts power supplied by the power supply module and generates power used for the operation of the electronic device 10.

At least one of the components of the electronic device 10 may be included in the display device 1. In addition, some of individual modules functionally included in one module may be included in the display device 1 and others may be provided separately from the display device 1. In an embodiment, for example, the display device 1 may include the display module 11, and the processor 12, the memory device 13, and the power module 14 may be provided in the form of other devices in the electronic device 10, other than the display device 1.

Referring to FIG. 12, various embodiments of the electronic device including the display device 1 may include an image display electronic device such as a smart phone 10_1a, a tablet personal computer (PC) 10_1b, a laptop computer 10_1c, a television (TV) 10_1d, a desk monitor 10_1e, and the like. In addition, the various electronic devices may include a wearable electronic device including the display module such as smart glasses 10_2a, a head mounted display 10_2b, a smart watch 10_2c, and the like. In addition, the various electronic device may include a vehicle electronic device 10_3 including the display module, such as an instrument panel, a center fascia, a center information display (CID) on a dashboard, a room mirror display, and the like. The electronic device 10 is not limited to the image display electronic device, the wearable electronic device and the vehicle electronic device 10_3.

Embodiments of the invention may be applied to a display device and an electronic device including the display device, for example, a TV, a digital TV, a three-dimensional (3D) TV, a mobile phone, a smart phone, a tablet computer, a laptop computer, a PC, a household electronic device, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An output buffer circuit comprising:
an input block which receives an input voltage and generates first and second control voltages based on the input voltage;
an output block which outputs an output voltage corresponding to the input voltage based on the first and second control voltages;
a first slew rate control block which receives the input voltage and controls a slew rate of the output voltage by generating a first control current, wherein the first control current controls the first and second control voltages based on the input voltage; and
a second slew rate control block which additionally controls the slew rate of the output voltage by generating a second control current, wherein the second control current additionally controls the first and second control voltages when the first control current is generated.

2. The output buffer circuit of claim 1, wherein the output block includes:
a first transistor including a control electrode connected to a first node to which the first control voltage is applied, a first electrode which receives a first voltage, and a second electrode connected to an output node at which the output voltage is output;
a second transistor including a control electrode connected to a second node to which the second control voltage is applied, a first electrode connected to the output node, and a second electrode which receives a second voltage;
a first capacitor including a first electrode connected to a third node and a second electrode connected to the output node; and
a second capacitor including a first electrode connected to the output node and a second electrode connected to a fourth node.

3. The output buffer circuit of claim 2, wherein the second slew rate control block includes:
a third transistor including a control electrode connected to a fifth node, a first electrode which receives the first voltage, and a second electrode connected to the fourth node; and
a fourth transistor including a control electrode connected to a sixth node, a first electrode connected to the third node, and a second electrode which receives the second voltage.

4. The output buffer circuit of claim 3, wherein when a voltage level of the input voltage is higher than a voltage level of a previous output voltage of the output node, the third transistor is turned off, the fourth transistor is turned on, the second control current flows from the third node through the fourth transistor, and a voltage level of the first control voltage decreases.

5. The output buffer circuit of claim 4, wherein when the voltage level of the first control voltage decreases, the first transistor is turned on, the second transistor is turned off, and the output voltage of the output node reaches a target voltage level.

6. The output buffer circuit of claim 3, wherein when a voltage level of the input voltage is lower than a voltage level of a previous output voltage of the output node, the third transistor is turned on, the fourth transistor is turned off, the second control current flows to the fourth node through the third transistor, and a voltage level of the second control voltage increases.

7. The output buffer circuit of claim 6, wherein when the voltage level of the second control voltage increases, the first transistor is turned off, the second transistor is turned on, and the output voltage of the output node reaches a target voltage level.

8. The output buffer circuit of claim 3, wherein the first slew rate control block includes:
a fifth transistor including a control electrode which receives the input voltage, a first electrode connected to a seventh node, and a second electrode connected to the output node;
a sixth transistor including a control electrode which receives the input voltage, a first electrode connected to the output node, and a second electrode connected to an eighth node;
a seventh transistor including a control electrode connected to the fifth node, a first electrode which receives the first voltage, and a second electrode connected to the third node;
an eighth transistor including a control electrode connected to the fifth node, a first electrode which receives the first voltage, and a second electrode connected to the fifth node;
a ninth transistor including a control electrode connected to the seventh node, a first electrode which receives the first voltage, and a second electrode connected to the sixth node;
a tenth transistor including a control electrode connected to the seventh node, a first electrode which receives the first voltage, and a second electrode connected to the seventh node;
an eleventh transistor including a control electrode connected to the sixth node, a first electrode connected to the fourth node, and a second electrode which receives the second voltage;
a twelfth transistor including a control electrode connected to the sixth node, a first electrode connected to the sixth node, and a second electrode which receives the second voltage;
a thirteenth transistor including a control electrode connected to the eighth node, a first electrode connected to the fifth node, and a second electrode which receives the second voltage; and
a fourteenth transistor including a control electrode connected to the eighth node, a first electrode connected to the eighth node, and a second electrode which receives the second voltage.

9. The output buffer circuit of claim 8, wherein when a voltage level of the input voltage is higher than a voltage level of a previous output voltage of the output node, the eleventh transistor is turned on, the first control current flows from the fourth node through the eleventh transistor, and a voltage level of the first control voltage decreases, and
wherein when the voltage level of the first control voltage decreases, the first transistor is turned on, the second transistor is turned off, and the output voltage of the output node reaches a target voltage level.

10. The output buffer circuit of claim 8, wherein when a voltage level of the input voltage is lower than a voltage level of a previous output voltage of the output node, the seventh transistor is turned on, the first control current flows to the third node through the seventh transistor, and a voltage level of the second control voltage increases, and
wherein when the voltage level of the second control voltage increases, the first transistor is turned off, the second transistor is turned on, and the output voltage of the output node reaches a target voltage level.

11. A display device comprising:
a display panel including a pixel;
a gate driver which provides a gate signal to the pixel;
a data driver including an output buffer circuit which provides an output voltage to the pixel;
a driving controller which controls the gate driver and the data driver,
wherein the output buffer circuit includes:
an input block which receives an input voltage and generates first and second control voltages based on the input voltage;
an output block which outputs the output voltage corresponding to the input voltage based on the first and second control voltages;
a first slew rate control block which receives the input voltage and controls a slew rate of the output voltage by generating a first control current, wherein the first control current controls the first and second control voltages based on the input voltage; and
a second slew rate control block which additionally controls the slew rate of the output voltage by generating a second control current, wherein the second control current additionally controls the first and second control voltages when the first control current is generated.

12. The display device of claim 11, wherein the output block includes:
a first transistor including a control electrode connected to a first node to which the first control voltage is applied, a first electrode which receives a first voltage, and a second electrode connected to an output node at which the output voltage is output;
a second transistor including a control electrode connected to a second node to which the second control voltage is applied, a first electrode connected to the output node, and a second electrode which receives a second voltage;
a first capacitor including a first electrode connected to a third node and a second electrode connected to the output node; and
a second capacitor including a first electrode connected to the output node and a second electrode connected to a fourth node, and
wherein the second slew rate control block includes:
a third transistor including a control electrode connected to a fifth node, a first electrode which receives the first voltage, and a second electrode connected to the fourth node; and
a fourth transistor including a control electrode connected to a sixth node, a first electrode connected to the third node, and a second electrode which receives the second voltage.

13. The display device of claim 12, wherein when a voltage level of the input voltage is higher than a voltage level of a previous output voltage of the output node, the third transistor is turned off, the fourth transistor is turned on, the second control current flows from the third node through the fourth transistor, and a voltage level of the first control voltage decreases.

14. The display device of claim 13, wherein when the voltage level of the first control voltage decreases, the first transistor is turned on, the second transistor is turned off, and the output voltage of the output node reaches a target voltage level.

15. The display device of claim 12, wherein when a voltage level of the input voltage is lower than a voltage level of a previous output voltage of the output node, the third transistor is turned on, the fourth transistor is turned off, the second control current flows to the fourth node through the third transistor, and a voltage level of the second control voltage increases.

16. The display device of claim 15, wherein when the voltage level of the second control voltage increases, the first transistor is turned off, the second transistor is turned on, and the output voltage of the output node reaches a target voltage level.

17. An electronic device comprising:
a processor which generates an input control signal and input image data;
a display panel including a pixel;
a gate driver which provides a gate signal to the pixel;
a data driver including an output buffer circuit which provides an output voltage to the pixel;
a driving controller which controls the gate driver and the data driver based on the input control signal and the input image data,
wherein the output buffer circuit includes:
an input block which receives an input voltage and generates first and second control voltages based on the input voltage;
an output block which outputs the output voltage corresponding to the input voltage based on the first and second control voltages;
a first slew rate control block which receives the input voltage and controls a slew rate of the output voltage by generating a first control current, wherein the first control current controls the first and second control voltages based on the input voltage; and
a second slew rate control block which additionally controls the slew rate of the output voltage by generating a second control current, wherein the second control current additionally controls the first and second control voltages when the first control current is generated.

18. The electronic device of claim 17, wherein the output block includes:
a first transistor including a control electrode connected to a first node to which the first control voltage is applied, a first electrode which receives a first voltage, and a second electrode connected to an output node at which the output voltage is output;
a second transistor including a control electrode connected to a second node to which the second control voltage is applied, a first electrode connected to the output node, and a second electrode which receives a second voltage;
a first capacitor including a first electrode connected to a third node and a second electrode connected to the output node; and
a second capacitor including a first electrode connected to the output node and a second electrode connected to a fourth node, and
wherein the second slew rate control block includes:
a third transistor including a control electrode connected to a fifth node, a first electrode which receives the first voltage, and a second electrode connected to the fourth node; and
a fourth transistor including a control electrode connected to a sixth node, a first electrode connected to the third node, and a second electrode which receives the second voltage.

19. The electronic device of claim 18, wherein when a voltage level of the input voltage is higher than a voltage level of a previous output voltage of the output node, the third transistor is turned off, the fourth transistor is turned on, the second control current flows from the third node through the fourth transistor, and a voltage level of the first control voltage decreases, and
wherein when the voltage level of the first control voltage decreases, the first transistor is turned on, the second transistor is turned off, and the output voltage of the output node reaches a target voltage level.

20. The electronic device of claim 18, wherein when a voltage level of the input voltage is lower than a voltage level of a previous output voltage of the output node, the third transistor is turned on, the fourth transistor is turned off, the second control current flows to the fourth node through the third transistor, and a voltage level of the second control voltage increases, and
wherein when the voltage level of the second control voltage increases, the first transistor is turned off, the second transistor is turned on, and the output voltage of the output node reaches a target voltage level.
